(19) United States
(12) Patent Application Publication
(10) Pub. No.: US 2013/0173126 A1
(43) Pub. Date: Jul. 4, 2013

(54) METHOD FOR ACTUATING A CLUTCH AND CONTROL SYSTEM FOR A MANUAL CHANGE-SPEED TRANSMISSION

(71) Applicant: GM Global Techonlogy Operations LLC, Detroit, MI (US)

(72) Inventor: Christian Ruebsam, Bodenheim (DE)

(73) Assignee: GM GLOBAL TECHNOLOGY OPERATIONS LLC, Detroit, MI (US)

(21) Appl. No.: 13/714,250

(22) Filed: Dec. 13, 2012

(30) Foreign Application Priority Data
Dec. 15, 2011 (DE) 102011121309.4

(51) Int. Cl. B60W 10/02

(52) U.S. Cl. CPC B60W 10/02
USPC 701/67; 477/175

(57) ABSTRACT

A method for actuating a clutch for coupling a manual change-speed transmission of a motor vehicle, in which the clutch can be actuated with the help of a clutch pedal, is provided. The method includes sensing a rotational speed of a motor of the motor vehicle that can be coupled to the change-speed transmission via the clutch and/or sensing a travelling speed of the motor vehicle and actuating the clutch independently of a position of the clutch pedal when the sensed rotational speed undershoots a predefined limit rotational speed and/or the sensed travelling speed undershoots a predefined limit travelling speed.

### CROSS-REFERENCE TO RELATED APPLICATIONS

This application claims priority to German Patent Application No. 10 2011 121 309.4, filed Dec. 15, 2012, which is incorporated herein by reference in its entirety.

### TECHNICAL FIELD

This application pertains to a method for actuating a clutch, a control system for a manual change-speed transmission, a computer program product, a computer program and a signal sequence, with the help of which a clutch can be actuated for coupling a motor of a motor vehicle to a manual change-speed transmission of the motor vehicle.

### BACKGROUND

It is known for actuating a manual change-speed transmission to actuate a clutch pedal in order to open a clutch connected between a motor of a motor vehicle and a manual change-speed transmission, to engage a gear at the manual change-speed transmission with the help of a shift lever and subsequently release the clutch pedal in order to close the clutch.

There is a need with motor vehicles having manual change-speed transmissions to increase the driving comfort. In addition, other objects, desirable features and characteristics will become apparent from the subsequent summary and detailed description, and the appended claims, taken in conjunction with the accompanying drawings and this background.

### SUMMARY

Various teachings of the present disclosure show measures which, with motor vehicles having a manual change-speed transmission, make possible a high driving comfort.

An exemplary embodiment of the present disclosure relates to a method for actuating a clutch for coupling a manual change-speed transmission of a motor vehicle, wherein the clutch can be actuated with the help of a clutch pedal, comprising: sensing a rotational speed of a motor that can be coupled to the change-speed transmission via the clutch and/or sensing a travelling speed of the motor vehicle and actuating the clutch independently of a position of the clutch pedal when the sensed rotational speed undershoots a predefined limit rotational speed and/or the sensed travelling speed undershoots a predefined limit travelling speed.

In that the clutch is actuated below the limit rotational speed and/or below the limit travelling speed independently of the pedal position of the clutch pedal, it is not necessary for a drive for example when maneuvering into or out of a parking bay or moving in a traffic congestion to actuate the clutch pedal. A repeated manual clutch engagement and disengagement in such situations is avoided. Because of this, a high travelling comfort is made possible with a motor vehicle having a manual change-speed transmission.

In one example, in driving situations with continuously slipping clutch, when the rotational speed of the clutch on the transmission side is to be deliberately lower than the rotational speed on the motor side, a particularly low-wear and efficient slipping actuation of the clutch can take place with the help of a suitable control, which a driver could only inadequately achieve through manual actuation. Situations, in which the motor is operated with a comparatively high rotational speed and high fuel consumption and the clutch is operated in a slipping manner in order to achieve a generally low travelling speed without stalling the motor can be avoided. Instead, the rotational speed of the motor can be automatically reduced and the clutch closed more in order to achieve the intended low travelling speed without stalling the engine. The mechanical loading of the clutch and the wear of friction linings of the clutch can be reduced because of this. Because of this, the lifespan of the clutch in particular can be increased.

It is possible, in one example, with a manual change-speed transmission below the limit rotational speed and/or below the limit travelling speed to achieve the functionality and the travelling comfort of an automatic transmission. Generally, it is possible below the limit rotational speed and/or below the limit travelling speed to control a locomotion of the motor vehicle solely by actuating a brake pedal. In one example, the method is only applied when the first gear (“starting gear”) or the reverse gear is engaged at the manual change-speed transmission. This makes it possible with a motor vehicle having a manual change-speed transmission to provide the functionality of a crawler gear, with which having to manually actuate the clutch with the help of the clutch pedal is not required. In one example, with the remaining forward gears, the application of the method is blocked with the help of a suitable control system. It is possible, furthermore, to terminate the application of the method and in one example to open the clutch when the driver actuates the brake pedal for stopping the motor vehicle and to re-apply the method and in particular to close the clutch in a slipping or full manner when the driver releases the brake pedal. In one example, the method is terminated when the driver with the help of an accelerator pedal accelerates the motor vehicle beyond the limit travelling speed and/or the motor beyond the limit rotational speed.

When actuating the clutch independently of a position of the clutch pedal, intermediate positions of the clutch pedal between the respective end positions remain disregarded. The actuation travel of the clutch does not follow a proportional or non-linear regulator characteristic curve which links the actuating position of the clutch with the position of the clutch pedal. Instead, an upper limit and a lower limit can be generally designed for the position of the clutch pedal, between which a detected position of the clutch pedal remains disregarded for the actuation of the clutch and is not further processed.

In one example, with the method, a clutch position is calculated which is to be activated independently of the position of the clutch pedal, in particular in order to make possible a crawling of the motor vehicle with a particularly low travelling speed. In one example, the calculated clutch position is compared with the clutch position which would materialize with the current clutch pedal position. In the case that the current clutch pedal position would produce a greater opening of the clutch than with the calculated clutch position, this can be interpreted in one example as driver request to terminate the automatic clutch actuation and change to the manual clutch actuation with the help of the clutch pedal so that the clutch position that is more greatly opened as defined via the clutch pedal position is activated. Generally, for as long as the sensed rotational speed undershoots a predefined limit rotational speed and/or the sensed travelling speed undershoots a predefined limit travelling speed, the calculated clutch pedal position can be subsequently compared with the clutch position which would materialize with the current clutch pedal position. In the case that the calculated clutch position would produce a greater opening of the clutch than with the actual clutch pedal position, it is possible to change again to the automatic actuation of the clutch so that the over calculated more greatly open clutch position is actuated.

In one example, the predefined limit travelling speed amounts to less than or equal to about 10 km/h, in one example, less than or equal to about 6 km/h, for example, less than or equal to about 4 km/h and in another example, less than or equal to about 3 km/h. Below such a limit travelling speed it can happen that travelling is to be performed with slipping clutch, so that these situations can be automatically and comfortably and efficiently controlled independently of the actual position of the clutch pedal. In one example, frequent repeated manual clutch engagement and disengagement for example in a traffic congestion can be avoided.

Generally, the clutch is actuated independently of the position of the clutch pedal in such a manner that for the motor vehicle a travelling speed v of about 0.5 km/h≦v≦about 7 km/h, in one example, about 1 km/h≦v≦about 6 km/h, in another example about 2 km/h≦v≦about 5 km/h and generally about 3 km/h≦v≦about 4 km/h is obtained. Such a travelling speed is suitable in one example, when maneuvering into a parking bay.

Generally, before reaching a stalling rotational speed of the motor, the clutch is opened independently of a position of the clutch pedal. When the driver actuates the brake pedal and because of this increases the resistance moment opposing the drive power of the motor, it is possible to automatically open the clutch timely before a stalling of the motor even when the driver has not actuated the clutch pedal. The driving comfort is further improved because of this.

In one example, the predefined limit rotational speed of the motor is selected as a function of an idle rotational speed of the motor. The idle rotationally speed in one example is a predefined rotational speed that is to be active at idle so that in particular with an increased drag moment for example because of a partially actuated brake an increased power is demanded from the motor of the motor vehicle. In the vicinity of the idle rotational speed, a generally slow travelling speed can be favorably achieved with the help of an automatically controlled crawler gear, generally without the actuation of an accelerator pedal being required for this purpose. A particularly slow crawler speed can be achieved when for example the brake pedal is additionally actuated so that because of the additional braking action the rotational speed can fall below the idle rotational speed. The limit rotational speed n_{G} compared with the idle rotational speed n_{L} of the motor can amount to for example about 1.01≦n_{L}/n_{G}≦about 1.50, for example, about 1.05≦n_{L}/n_{G}≦about 1.25, as a further example about 1.07≦n_{L}/n_{G}≦about 1.20 and generally about 1.10≦n_{L}/n_{G}≦about 1.15. The idle rotational speed of a motor can be for example between ≧about 650 rpm and ≦about 1,200 rpm.

Generally, the clutch is opened as soon as the sensed rotational speed of the motor compared with the predefined limit rotational speed of the motor percentage wise undershoots an amount of ≧about 5% to ≦about 20%. A stalling of the motor can be avoided through the timely opening of the clutch.

In one example, before reaching a critical resonance rotational speed of a drive train of the motor vehicle, wherein the drive train comprises the motor and the clutch, in particular before reaching a critical resonance rotational speed of a two-mass flywheel associated with the drive train, the clutch is opened or closed independently of a position of the clutch pedal. The critical resonance rotational speed for example is between ≧about 400 rpm and ≦about 600 rpm. An increased mechanical loading of the drive train, in one example of a torsional vibration damper such as for example a two-mass flywheel can be avoided because of this.

An exemplary embodiment of the present disclosure relates to a control system for a manual change-speed transmission for a motor vehicle, with a clutch, in order to connect a motor, generally a combustion engine with the change-speed transmission, a clutch pedal for actuating the clutch and a control electronic device, wherein a rotational speed of the motor and/or a travelling speed of the motor vehicle can be sensed through the control electronic device and the clutch can be actuated through the control electronic device upon an undershooting of the sensed rotational speed below a predefined limit rotational speed of the motor and/or upon an undershooting of the travelling speed below a limit travelling speed independently of a position of the clutch pedal. The control system can be designed and further developed in one example as explained above by way of the method. Because of this, a high travelling comfort is made possible with a motor vehicle having a manual change-speed transmission.

In one example, the clutch is connected via the control electronic device with the clutch pedal via at least one cable and/or via a cableless connection, for example, radio connection, wherein upon an actuation of the clutch pedal control signals for actuating the clutch can be transmitted to the control electronic device via the at least one cable and/or via the cableless connection and the clutch can be actuated by the control electronic device. In one example, the clutch can be actuated electromechanically and/or electromagnetically and/or electrohydraulically, so that generally a mechanical and/or hydraulic coupling of the clutch pedal with the clutch is eliminated. In one example, a resistance moment can be imposed on the clutch pedal which is independent of the actual resistance moment present at the clutch and can be generally sensed intuitively.

In one example, the control electronic device comprises at least one storage unit and at least one processor unit, wherein in the at least one storage unit data, generally a measured rotational speed for a comparison with the predefined limit rotational speed of the motor and/or a stored travelling speed of the motor vehicle for a comparison with the predefined limit travelling speed can be stored, and with the help of the processor unit the method can be carried out which can be designed and further developed as described above. In one example, it is possible to store and evaluate the time profile of the sensed data so that a predictive control of the clutch is possible.

An exemplary embodiment of the present disclosure relates to a transmission train for a motor vehicle having a manual change-speed transmission, with a control system, which can be designed and further developed as described above, for actuating the clutch for coupling the manual change-speed transmission. Because of this, a high driving comfort is made possible with a motor vehicle having a manual change-speed transmission.

An exemplary embodiment of the present disclosure relates to a drive train for a motor vehicle having a drive train that can be designed and further developed as described above, and a motor that can be coupled to the manual change-speed transmission via a clutch for driving the motor vehicle, wherein the clutch can be actuated with the help of the control system. Because of this, a high driving comfort is made possible with a motor vehicle having a manual change-speed transmission.

An exemplary embodiment of the present disclosure relates to a computer program product with program code means, which are stored on a computer-readable data carrier in order to carry out the method described above, when the computer program product is executed on a computer, in one example, in a control electronic device of a control system. The control system can be designed and further developed as described above. Because of this, a high driving comfort is made possible with a motor vehicle having a manual change-speed transmission.

An exemplary embodiment of the present disclosure relates to a computer program with encoded instructions for carrying out the method described above when the computer program is executed on a computer, in one example, of a control electronic device of a control system. The control system can be designed and further developed as described above. Because of this, a high driving comfort is made possible with a motor vehicle having a manual change-speed transmission. The computer program can be stored in particular on the computer program product described above, for example a diskette, CD-ROM, DVD, memory, a processor unit connected to the internet. The computer program can in one example, be configured as a compiled or un-compiled data sequence, which is generally based on a higher, in one example, object-based computer language such as for example C, C++, Java, Smalltalk, Pascal, Turbo Pascal.

An exemplary embodiment of the present disclosure relates to a signal sequence with computer-readable instructions for carrying out the method described above when the signal sequence is processed by a computer, in one example, of a control electronic device of a control system. The control system can be designed and further developed as described above. Because of this, a high driving comfort is made possible with a motor vehicle having a manual change-speed transmission. In one example, the signal sequence can be generated with the help of the computer program described above and/or with the help of the computer program product described above. The signal sequence can be provided as electrical impulses and/or electromagnetic wave and/or optical impulses in a wireless or wire-based manner.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a schematic representation of a drive train and

FIG. 2 shows a schematic flow diagram for a method for operating the drive train from FIG. 1.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

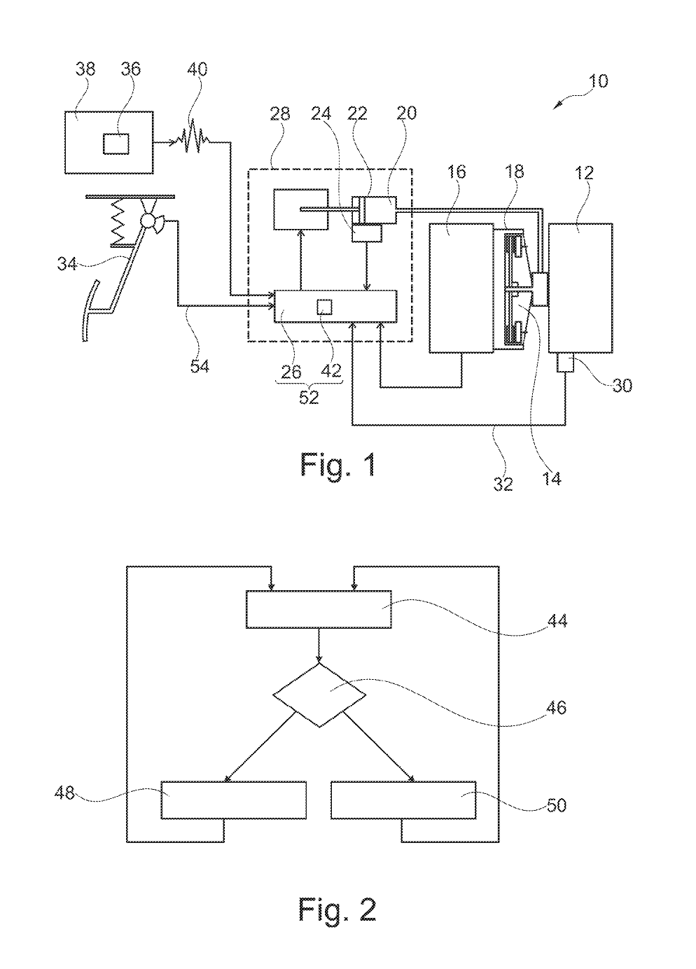

The drive train 10 shown in FIG. 1 comprises a manual change-speed transmission 12, which can be coupled to a motor 16, in one example, combustion engine, fuel cell or electric motor via a clutch 14. Between the motor 16 and the change-speed transmission 12, a torsional vibration damper, for example a two-mass flywheel 18, a dynamic rubber vibration absorber and/or a centrifugal pendulum can be provided in order to dampen torsional vibrations of the motor 16, which can in one example develop through a motoric combustion of a combustion engine.

The coupling 14 can be actuated with the help of an in one example, electrohydraulic or electromechanical actuator 20. With the help of the actuator 20, the clutch 14 can be opened, closed or operated in a slipping manner. In particular, a pressure force of the clutch 14 can be set with the help of the actuator 20. In the shown exemplary embodiment, the actuator 20 can generate the required actuation force for actuating the clutch 14 with the help of an electrically operated piston 22. The position of the piston 22 can be detected with the help of a distance sensor 24 and stored in a storage unit 26 of a control electronic device 52 of a control system 28, for example in order to sense for example the actuation position of the clutch 14. This makes possible in one example, a “closed loop” control section for controlling an actuation position of the clutch 14 to be activated, generally with slipping clutch 14.

In the storage unit 26, a rotational speed of the motor 12 sensed with the help of a revolution counter 30 and/or a travelling speed of a motor vehicle can likewise be stored with the drive train 10. In one example, the rotational speed of the motor 12 and/or the travelling speed of the motor vehicle and/or further motor and/or transmission control data can be read into the storage unit 26 via a CAN-bus 32. Furthermore, it is possible to sense a pedal position of a clutch pedal 34 and/or of an accelerator pedal and/or of a brake pedal, feeding it to the storage unit 26 of the control system 28 via a cable 54 for signal transmission or a cableless connection, for example radio or infrared connection, without mechanical couplings in an electronic manner.

Within the control system 28, the clutch 14 can be actuated as a function of the pedal position of the clutch pedal 34 or independently of the position of the clutch pedal 34 for an automated crawl drive with the help of the data stored in the storage unit 26. The method, according to which the control system 28 operates, can be stored as computer program 36 on a computer program product 38 in the form of a data memory and as signal sequence 40 operates the control system 28. The computer program product 48 can also be part of the control system 28, for example as processor unit 42 of the control electronic device 52 of the control system 28.

With the method shown in FIG. 2, a sensing of the rotational speed of the motor 12 and/or a sensing of a travelling speed of the motor vehicle takes place in a block 44. Following this, the sensed rotational speed is compared with a limit rotational speed and/or the sensed travelling speed compared with a limit travelling speed in a next block and checked if the relevant limit value, generally both limit values, are undershot. If this is the case, an actuating of the clutch 14 independently of the position of the clutch pedal 34 takes place in a block 48, in one example, in order to realize an automated crawl drive in the manner of an automatic transmission. This can in particular take place also with a partially actuated brake in order to achieve a generally slow travelling speed for the motor vehicle. If this is not the case, an actuating of the clutch 14 as a function of the position of the clutch pedal 34 takes place in a block 50 instead in the manner of a conventional manual change-speed transmission. After this, the method can be carried out anew with the block 44. Additionally or alternatively, the automatic actuation of the clutch 14 can be terminated in the block 50 if a stopping request, for example because of a sufficiently actuated brake pedal, is detected. In this case, the clutch 14 can be completely opened even without actuated clutch pedal 34 in order to stop the motor vehicle. In one example, the clutch 14 remains completely opened until the clutch pedal 34 is actuated again and the method is carried out again in particular with the block 44.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A method for actuating a clutch for coupling a manual change-speed transmission of a motor vehicle, wherein the clutch can be actuated with the help of a clutch pedal, comprising:
sensing at least one of a rotational speed of a motor of the motor vehicle that is couplable to the change-speed transmission via the clutch and a travelling speed of the motor vehicle; and
actuating the clutch independently of a position of the clutch pedal, when at least one of the sensed rotational speed undershoots a predefined limit rotational speed and the sensed travelling speed undershoots a predefined limit travelling speed.

2. The method according to claim 1, wherein the predefined limit travelling speed is less than or equal to about 10 km/h.

3. The method according to claim 1, wherein the predefined limit travelling speed is less than or equal to about 3 km/h.

4. The method according to claim 2, wherein the clutch is actuated independently of the position of the clutch pedal in such a manner that for the motor vehicle a travelling speed v of about 0.5 km/h≦v≦about 7 km/h is obtained.

5. The method according to claim 2, wherein the clutch is actuated independently of the position of the clutch pedal in such a manner that for the motor vehicle a travelling speed v of about 3 km/h≦v≦about 4 km/h is obtained.

6. The method according to claim 1, wherein before reaching a stalling rotational speed of the motor the clutch is opened independently of a position of the clutch pedal.

7. The method according to claim 1, wherein the predefined limit rotational speed of the motor is selected as a function of an idle rotational speed of the motor.

8. The method according to claim 1, wherein the clutch is opened as soon as the sensed rotational speed of the motor in comparison with the predefined limit rotational speed of the motor percentage wise undershoots an amount of ≧about 5% to ≦about 20%.

9. The method according to claim 1, wherein reaching a critical resonance rotational speed of a two-mass flywheel associated with the drive train, the clutch is opened or closed independently of a position of the clutch pedal.

10. A control system for a manual change-speed transmission for a motor vehicle comprising:
a clutch in order to connect a combustion engine, with the change-speed transmission;
a clutch pedal for actuating the clutch; and
a control electronic device,
wherein at least one of a rotational speed of the motor and a travelling speed of the motor vehicle is sensed by the control electronic device and the clutch is actuated by the control electronic device upon at least one of an undershooting of the sensed rotational speed below a predefined limit rotational speed of the motor and an undershooting of the travelling speed below a limit travelling speed independently of a position of the clutch pedal.

11. The control system according to claim 10, wherein the clutch via the control electronic device is connected to the clutch pedal via at least one of a cable and a cableless connection, wherein upon an actuation of the clutch pedal control signals for actuating the clutch are transmitted to the control electronic device via the at least one cable and cableless connection and the clutch is actuated by the control electronic device.

12. The control system according to claim 10, wherein the clutch via the control electronic device is connected to the clutch pedal via a radio connection.

13. The control system according to claim 11, wherein the control electronic device further comprises at least one storage unit and at least one processor unit, wherein in the at least one storage unit, at least one of a measured rotational speed for a comparison with the predefined limit rotational speed of the motor and a stored travelling speed of the motor vehicle for a comparison with the predefined limit travelling speed is stored.

14. A motor vehicle, comprising:
a drive train including a manual change-speed transmission; and
a motor that can be coupled to the manual change-speed transmission via a clutch for driving the motor vehicle, wherein the clutch can be actuated by a control electric device that:
senses at least one of a rotational speed of a motor of the motor vehicle is couplable to the change-speed transmission via the clutch and a travelling speed of the motor vehicle; and
actuates the clutch independently of a position of the clutch pedal, when at least one of the sensed rotational speed undershoots a predefined limit rotational speed and the sensed travelling speed undershoots a predefined limit travelling speed.

15. A computer program product, comprising:
a storage unit readable by a processor unit and storing instructions for execution by the processor unit for performing a method comprising:
sensing at least one of a rotational speed of a motor of the motor vehicle is couplable to the change-speed transmission via the clutch and a travelling speed of the motor vehicle; and
actuating the clutch independently of a position of the clutch pedal, when at least one of the sensed rotational speed undershoots a predefined limit rotational speed and the sensed travelling speed undershoots a predefined limit travelling speed.
